(19) United States
(12) Patent Application Publication
(10) Pub. No.: US 2010/0165310 A1
(43) Pub. Date: Jul. 1, 2010

(54) EUV Mask Inspection

(75) Inventors: Harry SEWELL, Ridgefield, CT (US); Stoyan Nihtianov, Eindhoven (NL); Luigi Scaccabarozzi, Valkenswaard (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Holding N.V., Veldhoven (NL)

(21) Appl. No.: 12/582,825

(22) Filed: Oct. 21, 2009

Related U.S. Application Data
(60) Provisional application No. 61/142,114, filed on Dec. 31, 2008.
(60) Provisional application No. 61/149,119, filed on Feb. 2, 2009.

(51) Int. Cl. G03B 27/42

(52) U.S. Cl. 355/53; 355/77

(57) ABSTRACT

A system for inspecting an extreme ultra violet (EUV) mask. The system includes an array of sensors and an optical system. The array of sensors is configured to produce analog data corresponding to received optical energy. The optical system is configured to direct EUV light from an inspection area of an EUV patterning device onto the array of sensors, whereby the analog data is used to determine defects or to compensate for irregularities found on the EUV mask.

### CROSS REFERENCE TO RELATED APPLICATIONS

This application claims benefit under 35 U.S.C.§119(e) to U.S. Provisional Patent Applications: 61/142,114, filed Dec. 31, 2008, and 61/149,119, filed Feb. 2, 2009, which are both incorporated by reference herein in their entireties.

### BACKGROUND

1. Field

Embodiments of the present invention relate inspection systems, for example inspection systems for inspecting extreme ultra-violet (EUV) masks in lithography systems that can be used to manufacture devices.

2. Background

Lithography is widely recognized as a key process in manufacturing integrated circuits (ICs) as well as other devices and/or structures. A lithographic apparatus is a machine, used during lithography, which applies a desired pattern onto a substrate, such as onto a target portion of the substrate. During manufacture of ICs with a lithographic apparatus, a patterning device (which is alternatively referred to as a mask or a reticle) generates a circuit pattern to be formed on an individual layer in an IC. This pattern may be transferred onto the target portion (e.g., comprising part of, one, or several dies) on the substrate (e.g., a silicon wafer). Transfer of the pattern is typically via imaging onto a layer of radiation-sensitive material (e.g., resist) provided on the substrate. In general, a single substrate contains a network of adjacent target portions that are successively patterned. Manufacturing different layers of the IC often requires imaging different patterns on different layers with different reticles. Therefore, reticles must be changed during the lithographic process.

Even small defects or irregularities in a pattern on a patterning device can lead to large problems with devices formed on a substrate. In some cases, the small defects can render the formed devices inoperable. In order to meet modern day quality requirements, semiconductor lithography requires that patterns be inspected for defects. To that end, inspection systems have been developed to provide defect inspection detection apparatus.

Typically, pattern defect detection systems are available for illumination wavelengths as small as 50 nm. However, modern semiconductor lithography uses much lower wavelengths in order to obtain the smaller circuit feature dimensions used in today's semiconductor circuits. EUV (extreme ultra-violet) sources (i.e., having a wavelength of 5 nm or above) provide suitable illumination, with sources producing wavelengths as small as 11 nm being used. However, most conventional inspection systems cannot accurately detect wavelengths in the EUV range. In addition, the mask inspection apparatus must be compatible with the throughput demands of the current lithography process. However, at the state-of-the-art EUV frequencies, the available radiation intensity levels typically pose significant challenges.

### BRIEF SUMMARY

What is needed is a system and method for inspecting EUV masks and/or inspection systems utilizing EUV wavelengths of light to inspect objects.

In a first embodiment, there is provided a system for inspecting an EUV mask. The system includes an array of sensors and an optical system. The array of sensors is configured to produce analog data corresponding to received optical energy. The optical system is configured to direct EUV light from an inspection area of an EUV patterning device onto the array of sensors, whereby the analog data is used to determine defects or to compensate for irregularities (such as optical proximity correction) found on the EUV mask.

In one example, the array of sensors comprises charge coupled devices.

In one example, the system further comprises a converter that converts the analog data to digital data to be used for the compensation.

In a second embodiment, there is provided an extreme ultra-violet (EUV) mask inspection method. A beam of EUV radiation is directed onto a scanning EUV mask, which results in a patterned beam of EUV radiation. The patterned beam of radiation is received on an EUV detector array. The EUV detector array comprises a plurality of photosensitive elements. The plurality of photosensitive elements are arranged in a two-dimensional array with multiple columns of cells along a longitudinal axis and formed on a substrate. Each photosensitive element generates an electrical charge in response to illumination by a beam of EUV radiation that has been patterned by a scanning EUV mask. Each photosensitive element is electrically coupled to an adjacent photosensitive element, such that accumulated electrical charge in each photosensitive element is switchably transferable to the adjacent photosensitive element in synchronicity with the illuminated scanning EUV mask. An analog-to-digital converter (ADC) is coupled to one of the photosensitive elements disposed at an edge of each column of the two-dimensional array. A signal is output from the ADC.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIGS. 1A and 1B respectively depict reflective and transmissive lithographic apparatuses.

FIG. 2 illustrates a CCD detector array, according to an embodiment of the present invention.

FIG. 3 illustrates a configuration for a EUV mask inspection system, according to an embodiment of the present invention.

FIG. 4 provides a flowchart of a method for EUV mask inspection, in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

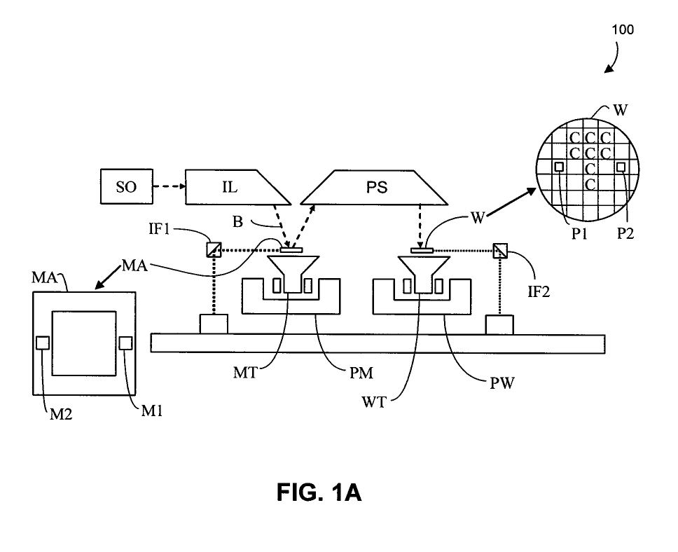

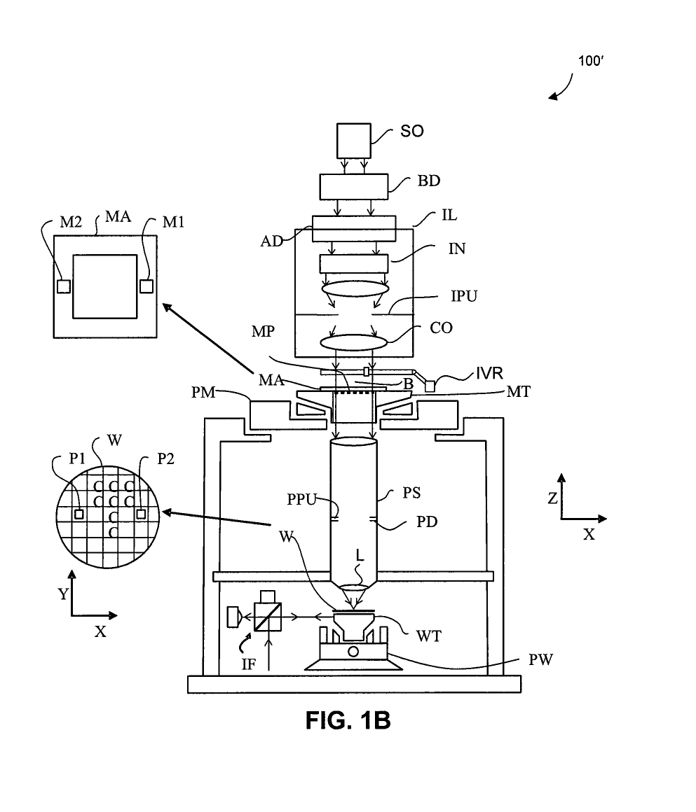

FIGS. 1A and 1B schematically depict lithographic apparatus 100 and lithographic apparatus 100′, respectively. Lithographic apparatus 100 and lithographic apparatus 100′ each include: an illumination system (illuminator) IL configured to condition a radiation beam B (e.g., DUV or EUV radiation); a support structure (e.g., a mask table) MT configured to support a patterning device (e.g., a mask, a reticle, or a dynamic patterning device) MA and connected to a first positioner PM configured to accurately position the patterning device MA; and a substrate table (e.g., a wafer table) WT configured to hold a substrate (e.g., a resist coated wafer) W and connected to a second positioner PW configured to accurately position the substrate W. Lithographic apparatuses 100 and 100′ also have a projection system PS configured to project a pattern imparted to the radiation beam B by patterning device MA onto a target portion (e.g., comprising one or more dies) C of the substrate W. In lithographic apparatus 100 the patterning device MA and the projection system PS is reflective, and in lithographic apparatus 100′ the patterning device MA and the projection system PS is transmissive.

The illumination system IL may include various types of optical components, such as refractive, reflective, magnetic, electromagnetic, electrostatic or other types of optical components, or any combination thereof, for directing, shaping, or controlling the radiation B.

The support structure MT holds the patterning device MA in a manner that depends on the orientation of the patterning device MA, the design of the lithographic apparatuses 100 and 100′, and other conditions, such as for example whether or not the patterning device MA is held in a vacuum environment. The support structure MT may use mechanical, vacuum, electrostatic or other clamping techniques to hold the patterning device MA. The support structure MT may be a frame or a table, for example, which may be fixed or movable, as required. The support structure MT may ensure that the patterning device is at a desired position, for example with respect to the projection system PS.

The term “patterning device” MA should be broadly interpreted as referring to any device that may be used to impart a radiation beam B with a pattern in its cross-section, such as to create a pattern in the target portion C of the substrate W. The pattern imparted to the radiation beam B may correspond to a particular functional layer in a device being created in the target portion C, such as an integrated circuit.

The patterning device MA may be transmissive (as in lithographic apparatus 100′ of FIG. 1B) or reflective (as in lithographic apparatus 100 of FIG. 1A). Examples of patterning devices MA include reticles, masks, programmable mirror arrays, and programmable LCD panels. Masks are well known in lithography, and include mask types such as binary, alternating phase shift, and attenuated phase shift, as well as various hybrid mask types. An example of a programmable mirror array employs a matrix arrangement of small mirrors, each of which may be individually tilted so as to reflect an incoming radiation beam in different directions. The tilted mirrors impart a pattern in the radiation beam B that is reflected by the mirror matrix.

The term “projection system” PS may encompass any type of projection system, including refractive, reflective, catadioptric, magnetic, electromagnetic and electrostatic optical systems, or any combination thereof, as appropriate for the exposure radiation being used, or for other factors, such as the use of an immersion liquid or the use of a vacuum. A vacuum environment may be used for EUV or electron beam radiation since other gases may absorb too much radiation or electrons. A vacuum environment may therefore be provided to the whole beam path with the aid of a vacuum wall and vacuum pumps.

Lithographic apparatus 100 and/or lithographic apparatus 100′ may be of a type having two (dual stage) or more substrate tables (and/or two or more mask tables) WT. In such “multiple stage” machines the additional substrate tables WT may be used in parallel, or preparatory steps may be carried out on one or more tables while one or more other substrate tables WT are being used for exposure.

Referring to FIGS. 1A and 1B, the illuminator IL receives a radiation beam from a radiation source SO. The source SO and the lithographic apparatuses 100, 100′ may be separate entities, for example when the source SO is an excimer laser. In such cases, the source SO is not considered to form part of the lithographic apparatuses 100 or 100′, and the radiation beam B passes from the source SO to the illuminator IL with the aid of a beam delivery system BD (FIG. 1B) comprising, for example, suitable directing mirrors and/or a beam expander. In other cases, the source SO may be an integral part of the lithographic apparatuses 100, 100′—for example when the source SO is a mercury lamp. The source SO and the illuminator IL, together with the beam delivery system BD, if required, may be referred to as a radiation system.

The illuminator IL may comprise an adjuster AD (FIG. 1B) for adjusting the angular intensity distribution of the radiation beam. Generally, at least the outer and/or inner radial extent (commonly referred to as Υ-outer and Υ-inner, respectively) of the intensity distribution in a pupil plane of the illuminator may be adjusted. In addition, the illuminator IL may comprise various other components (FIG. 1B), such as an integrator IN and a condenser CO. The illuminator IL may be used to condition the radiation beam B, to have a desired uniformity and intensity distribution in its cross section.

Referring to FIG. 1A, the radiation beam B is incident on the patterning device (e.g., mask) MA, which is held on the support structure (e.g., mask table) MT, and is patterned by the patterning device MA. In lithographic apparatus 100, the radiation beam B is reflected from the patterning device (e.g., mask) MA. After being reflected from the patterning device (e.g., mask) MA, the radiation beam B passes through the projection system PS, which focuses the radiation beam B onto a target portion C of the substrate W. With the aid of the second positioner PW and position sensor IF2 (e.g., an interferometric device, linear encoder or capacitive sensor), the substrate table WT may be moved accurately, e.g. so as to position different target portions C in the path of the radiation beam B. Similarly, the first positioner PM and another position sensor IF1 may be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

Referring to FIG. 1B, the radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g., an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1B) can be used to accurately position the mask MA with respect to the path of the radiation beam B, e.g., after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (known as scribe-lane alignment marks). Similarly, in situations in which more than one die is provided on the mask MA, the mask alignment marks may be located between the dies.

The lithographic apparatuses 100 and 100′ may be used in at least one of the following modes:

1. In step mode, the support structure (e.g., mask table) MT and the substrate table WT are kept essentially stationary, while an entire pattern imparted to the radiation beam B is projected onto a target portion C at one time (i.e., a single static exposure). The substrate table WT is then shifted in the X and/or Y direction so that a different target portion C may be exposed.

2. In scan mode, the support structure (e.g., mask table) MT and the substrate table WT are scanned synchronously while a pattern imparted to the radiation beam B is projected onto a target portion C (i.e., a single dynamic exposure). The velocity and direction of the substrate table WT relative to the support structure (e.g., mask table) MT may be determined by the (de-)magnification and image reversal characteristics of the projection system PS.

3. In another mode, the support structure (e.g., mask table) MT is kept substantially stationary holding a programmable patterning device, and the substrate table WT is moved or scanned while a pattern imparted to the radiation beam B is projected onto a target portion C. A pulsed radiation source SO may be employed and the programmable patterning device is updated as required after each movement of the substrate table WT or in between successive radiation pulses during a scan. This mode of operation may be readily applied to maskless lithography that utilizes programmable patterning device, such as a programmable mirror array of a type as referred to herein.

Combinations and/or variations on the described modes of use or entirely different modes of use may also be employed.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

In a further embodiment, lithographic apparatus 100 includes an extreme ultraviolet (EUV) source, which is configured to generate a beam of EUV radiation for EUV lithography. In general, the EUV source is configured in a radiation system (see below), and a corresponding illumination system is configured to condition the EUV radiation beam of the EUV source.

In the embodiments described herein, the terms “lens” and “lens element,” where the context allows, may refer to any one or combination of various types of optical components, comprising refractive, reflective, magnetic, electromagnetic and electrostatic optical components.

Further, the terms “radiation” and “beam” used herein encompass all types of electromagnetic radiation, comprising ultraviolet (UV) radiation (e.g., having a wavelength of 365, 248, 193, 157 or 126 nm), extreme ultra-violet (EUV or soft X-ray) radiation (e.g., having a wavelength in the range of 5-20 nm, e.g., 13.5 nm), or hard X-ray working at less than 5 nm, as well as particle beams, such as ion beams or electron beams. Generally, radiation having wavelengths between about 780-3000 nm (or larger) is considered IR radiation. UV refers to radiation with wavelengths of approximately 100-400 nm. Within lithography, it is usually also applied to the wavelengths, which can be produced by a mercury discharge lamp: G-line 436 nm; H-line 405 nm; and/or I-line 365 nm. Vacuum UV, or VUV (i.e., UV absorbed by air), refers to radiation having a wavelength of approximately 100-200 nm. Deep UV (DUV) generally refers to radiation having wavelengths ranging from 126 nm to 428 nm, and in an embodiment, an excimer laser can generate DUV radiation used within lithographic apparatus. It should be appreciated that radiation having a wavelength in the range of, for example, 5-20 nm relates to radiation with a certain wavelength band, of which at least part is in the range of 5-20 nm.

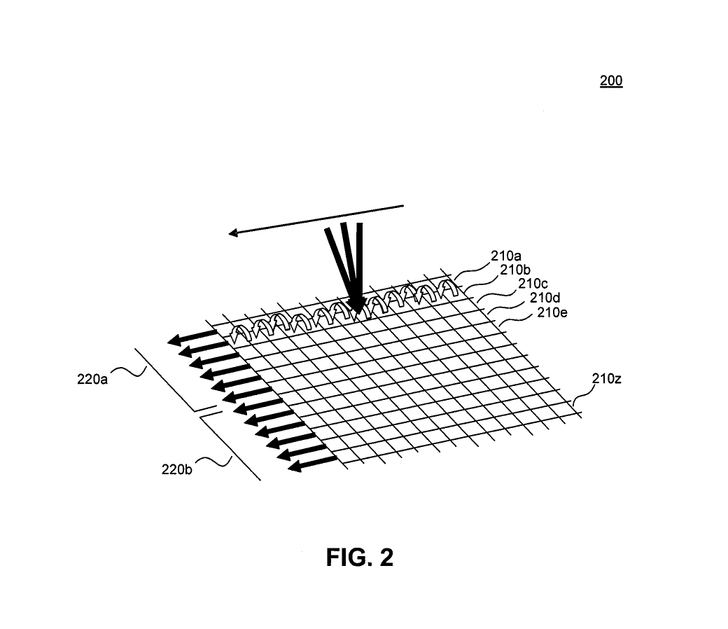

FIG. 2 illustrates charge coupled devices (CCD) 200, according to an embodiment of the present invention. In one example, CCD 200 comprises a two-dimensional array including 1-dimensional columns 210a through 210z that are configured side-by-side. Each one-dimensional column 210a through 210z comprises a number of elements (also known as photo detectors, detectors, photo sensitive elements, picture elements or pixels), each of which is coupled to the neighboring or adjacent pixel in the longitudinal direction of the one-dimensional column involved. In one example, CCD 200 may have a frequency sensitivity that covers a wide frequency range through to extreme ultraviolet frequencies, allowing for its use in EUV inspection systems, which is discussed in more detail below.

In operation, photons emanating from a beam of radiation, e.g., an image, are incident upon a pixel in CCD 200. Upon receipt of these photons, each pixel generates electrons in response to the number of photons received by that pixel, e.g., analog data. The number of received photons is related directly to the intensity of the beam (or image segment) and a time interval over which the pixel is exposed to that image segment. Accordingly, the electron charge output of each pixel is representative of the number of photons that were incident on that pixel.

In this example, the electron charge generated is then transferred in accordance with the circuit architecture of the CCD 200. In this example, charge transference proceeds through the interconnections from one pixel to the neighboring pixel along the column. Electronic charge from each pixel is accumulated as it is transferred between pixel to adjacent pixel until it reaches the terminal pixel in that column. In one example, timing of the inter-pixel transfer is typically governed by an external control circuit (not shown). The terminal pixel in each column then makes the total accumulated electronic charge generated available to its respective CCD output terminal 220. In one example, a plurality of CCD output terminals 220a, 220b can be used to group several output columns to a single terminal. However, those skilled in the relevant art(s) will recognize that such is an example of an interconnection architecture, and not a limitation. The output from terminals 220 is analog, and includes analog data representative of the received photons.

In one example, time delay integration (TDI) is used to process the analog data generated by each pixel. As described above, an image segment is scanned in the direction of the one-dimensional columns of CCD 200. In TDI, the scanning is time-synchronized with the electronic charge transfer from one pixel to its adjacent pixel in the longitudinal direction of the column. Accordingly, each adjacent pixel in the longitudinal direction of the column is thereby sequentially illuminated by the same image segment. Because of the architectural coupling between adjacent pixels, the currently illuminated pixel receives the electron charge generated by its neighboring pixel, and then contributes its own generated electron charge. Both the current pixel and the neighboring pixel are illuminated in turn by the same image segment. By transferring accumulated electron charge in a manner that is time synchronized to the scanning, the charge from each pixel in a given column is “integrated up” (or accumulated) as the image segment sequentially illuminates the entire one-dimensional array of pixels.

In one example, TDI allows an image segment to be detected and accurately measured by CCD 200 at extremely low illumination levels. For example, photon doses of less than one (1) photon per pixel can be measured using TDI. Also, in one example, repeatedly illuminating the same image segment over adjacent pixels results in reinforcement of the same image segment, while the uncorrelated noise (e.g., shot noise) cumulatively averages towards zero. Accordingly, TDI may result in an increased image-to-noise ratio, and consequently the detection and measurements of reduced image levels. In one example, the higher the number of pixels per one-dimensional array of CCD 200, the lower the resulting noise level, the greater the image-to-noise ratio, and the greater the sensitivity level. Thus, through using a CCD 200 and TDI processing, EUV wavelengths can be accurately detected.

As noted above, in TDI, the accumulated electron charge in CCD 200 is sequentially clocked from one pixel to its adjacent pixel. In one example, such sequential clocking occurs at a rate of one pixel per clock step. In various other embodiments, a clocking frequency can be greater than 1 MHz, with 1 MHz translating into a rate of one pixel per 1 μs step.

In one example, inspection throughput can be increased by increasing a size, or using more than one, CCD 200. For example, CCD 200 may be about 25 mm by 25 mm, although CCD 200 can be as large as about 125 mm by 125 mm.

Resolution of CCD 200 is governed by pixel size. For example, pixel size can be about 1 μm by 1 μm. However, the pixel size can be as large as about 10 μm by 10 μm, or as small as about 0.1 μm by 0.1 μm. It should be noted that the actual sensor area of CCD 200 is often less than the array size. For example, the actual sensor area can be approximately 80% of the array size.

In various embodiments of the present invention, CCD 200 can be fabricated such that it may be illuminated by EUV radiation from its front-side. However, front-side illumination poses challenges when using high frequency radiation such as EUV radiation since such high energy photons tend to be absorbed. In other embodiments of the present invention, CCD 200 can be fabricated to support EUV illumination from the backside of the substrate.

Skilled artisans in the relevant art(s) will recognize that the scope of the present invention is not limited to CCD-based pixels. Rather, other applicable arrays of photosensitive element of the appropriate size to support the resolution required in the mask inspection, and responsive to the frequency of illumination that is projected onto the mask undergoing inspection, can also be used.

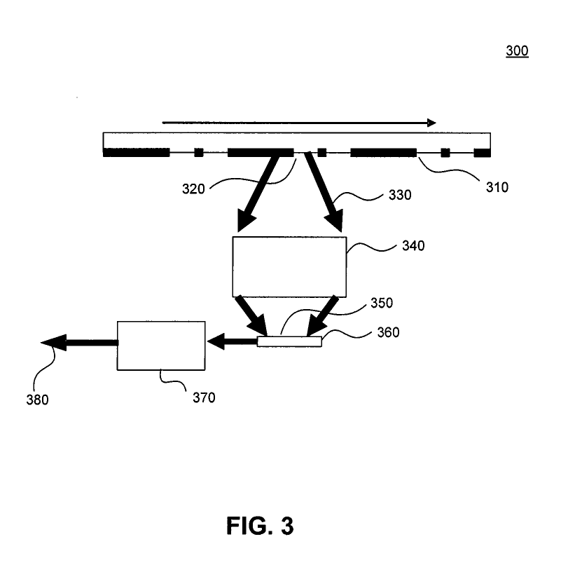

FIG. 3 illustrates an inspection system 300 (e.g., an EUV mask inspection system), according to an embodiment of the present invention. Inspection system 300 includes an optional optical system 340 (e.g., an EUV wavelength optical system), a detector 360 (e.g., CCD 200), and an optional converter 370 (e.g., an analog to digital converter or ADC). Although most of the description is discussed in terms of converting the analog data from the detector 360 into digital data, this may not always be necessary, and the present invention is not to be limited by this one embodiment.

In one example, an object 310 (e.g., an EUV mask) is illuminated with EUV radiation (i.e. radiation with a wavelength less than 50 nm, for example approximately 11.2 nm, 13.4 nm, etc., and including wavelengths beyond traditional EUV wavelengths such as 1-10 nm.), while being scanned in the direction of the arrow. For example, the EUV radiation may be from an inspection illumination source (not shown), while in other examples the illumination may be from a main lithography system illumination source. The incident EUV radiation illuminates an inspection zone or area 320 within EUV mask 310 to produce inspection radiation 330. Inspection radiation 330 is directed using optical system 340 onto detector 360. In one example, optical system 340 is sized to correspond to a size of active area 350 of detector 360.

In this example, ADC 370 receives analog data from detector 360. ADC 370 produces digital data from the received analog data. The digital signals may be fed to other aspects of a lithography system and used to adjust or compensate for any defects or irregularities found in the mask. For example, elements within or an illumination system or projection system can be adjusted for any irregularities found in the mask, such that more accurate and optimal devices are formed on the substrate.

In various examples, digital data can travel through connection(s) 380 to other parts of a lithography system utilizing inspection system 300, for example to either of the systems shown in FIGS. 1A and 1B to control aspects of the systems based on the characteristics of EUV mask 310. For example, the connections may be individual connections for each data channel, multi-channel data connections, as well as connections using a wide variety of media including but not limited to hardwired bus, optical fiber, and coaxial cabling. Persons skilled in the relevant art(s) will recognize that any form of connection suitable for multi-channel data connectivity falls within the scope of the present invention. By way of example and not of limitation, data output rates in excess of 1 GB/s can be output from EUV mask inspection system 300.

In one example, EUV mask 310 can be completely inspected in less than 15 minutes using a 40 nm pixel resolution.

As noted above, the output data can be used to determine defects or to compensate for irregularities (such as optical proximity correction) found in an EUV mask. In one example, the output data resulting from two nominally identical features on an EUV mask can be compared. Typically, the output data from the first identical feature is stored in memory. The data is then compared to subsequently obtained output data from the second identical feature. A comparison of the two output data is used to determine the presence of defects or irregularities in the EUV mask. Alternatively, a comparison can be performed for an intramask data comparison to the comparison of data resulting from nominally identical features residing on two different masks.

In another example, the output data from the inspection of an EUV mask is tagged with the location coordinates associated with the particular inspection area from which the output data was measured. Accordingly, the output data from two or more nominally identical features in different locations on a single EUV mask can be compared to determine the presence of defects or irregularities in the particular EUV mask.

In a still further example, a simulation is performed to determine the desired characteristics of the patterned beam, which is expected to result from the EUV mask. Such simulation data is stored in a database for later comparison with scanned data from the EUV mask. As before, the comparison of the output data with the stored simulation data is used to determine the presence of defects or irregularities in the EUV mask.

In a further embodiment of the present invention, additional inspection throughput can be achieved through the use of multiple detectors 360 that are coupled together. By linking such systems in parallel, additional columns of pixels can be exposed to the EUV mask being inspected during a single scan, versus the use of multiple scans.

In this example, object 310 (e.g., an EUV mask) is scanned in the direction of the arrow. The use of the terms “scanned” and “scanning” are intended to include any form of relative motion between object 310 and detector 360 in the direction indicated by the arrow. Relative motion includes the case where object 310 is moving and detector 360 is stationary, the case object 310 is stationary and detector 360 is moving, and the case object 310 and detector 360 are both moving. Persons skilled in the relevant art(s) will recognize that there are a variety of actuating systems that can be used to effectuate such relative motion. Note that in embodiments where detector 360 is in motion, the inspection radiation moves in synchronicity with detector 360. In an embodiment of the present invention, an actuator (not shown) is coupled to at least one of the incident EUV illumination, object 310 (e.g., an EUV mask), and detector 360.

It is to be appreciated that the inspection system 300 can be used to inspect other objects, i.e., other objects than an EUV mask, where the objects are inspected using EUV wavelengths of light. An EUV mask is merely an exemplary object being inspected in this embodiment of the present invention.

Finally, in an alternative embodiment, inspection of object 310 (e.g., an EUV mask) by detector 360 may be performed in a static mode, i.e. where there is no relative motion between object 310 (e.g., an EUV mask) and detector 360. In a static mode, scanning is not employed and therefore TDI is not used. In this scenario, a static image is captured by detector 360, output is made available from detector 360 and such output is then subsequently processed by optional converter 370.

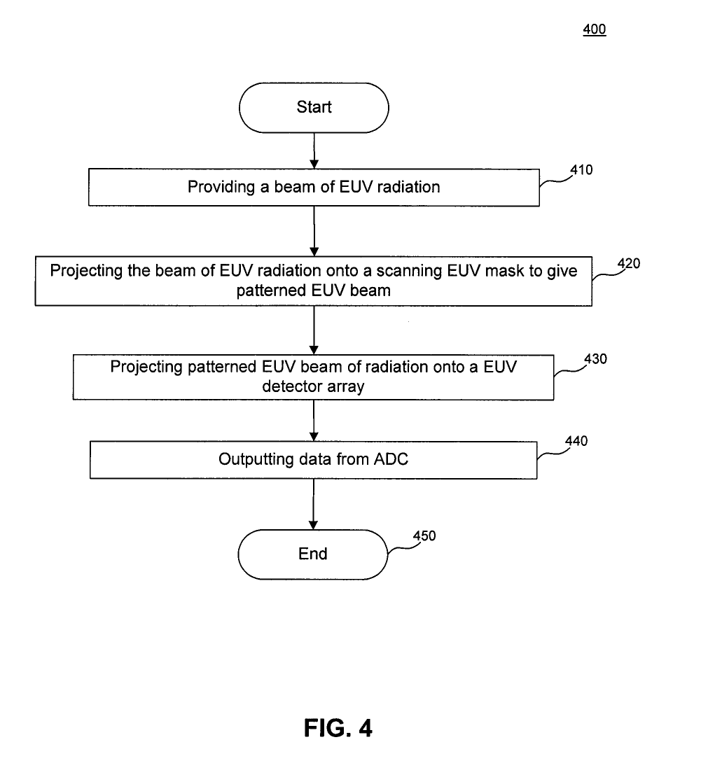

FIG. 4 is a flowchart of an exemplary method 400, according to an embodiment of the invention. For example, method 400 may be used to inspect an object, e.g., an EUV mask, using a detector, e.g., a CCD array. For example, method 400 may be carried out using one or more systems described above in FIGS. 1A, 1B, 2, and 3.

The process begins at step 410. In step 410, a beam of EUV radiation is received. The beam of EUV radiation may be provided, for example, by radiation source SO, as illustrated in FIGS. 1A and 1B or by a dedicated EUV radiation source in an inspection system, separate from radiation source of the lithography system.

In step 420, the EUV beam of radiation interacts with a scanning EUV mask, producing an inspection EUV beam of radiation.

In step 430, the inspection EUV beam of radiation is directed onto a detector, which generates an output. In one example, the output is generated using a time delay integration approach synchronized with the scanning EUV mask. For example, the output can be analog data.

In step 440, output from EUV detector array is transmitted, optionally after analog-to-digital converting, for further analysis for mask defects and/or further control of the lithography system.

At step 450, method 400 ends.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A system, comprising:
an array of sensors configured to produce analog data corresponding to received optical energy; and
an optical system configured to direct extreme ultra-violet (EUV) light from an inspection area of an EUV patterning device onto the array of sensors; whereby the analog data is used to determine defects or to compensate for irregularities found on the EUV mask.

2. The system of claim 1, wherein the array of sensors comprises an array of charge coupled devices (CCDs).

3. The system of claim 2, wherein the CCD array comprises a two-dimensional CCD array.

4. The system of claim 1, wherein the array of sensors is configured to use time delay integration to process the analog data generated by each sensor in the array of sensors.

5. The system of claim 1, wherein the EUV light comprises light having a wavelength of less than about 50 nm.

6. The system of claim 1, wherein the EUV light comprises light having a wavelength of about 13.4 nm.

7. The system of claim 1, wherein the EUV light comprises light having a wavelength of about 11.2 nm.

8. The system of claim 1, wherein the array of sensors is configured to produce the analog data when the EUV light is equal to or less than about 1 photon per sensor of the array of sensors.

9. The system of claim 1, wherein the array of sensors is sized to correlate to a size of the inspection area of the EUV patterning device, whereby inspection throughput is increased based on receiving all illumination from the inspection area substantially simultaneously.

10. The system of claim 1, further comprising:
a support device configured to support the EUV mask when the EUV mask patterns another EUV beam of radiation; and a projection system configured to project the patterned EUV beam onto a target portion of a substrate.

11. The system of claim 1, further comprising:
an analog-to-digital converter; and a controller configured to control portions of a lithography system, the lithography system configured to use the EUV patterning device to pattern a substrate, based on the digital data.

12. An extreme ultra-violet (EUV) mask inspection system, comprising:
a plurality of photosensitive elements arranged in a one-dimensional array having a longitudinal axis, and formed on a substrate,
wherein each photosensitive element generates an electrical charge in response to illumination by a beam of EUV radiation that has been patterned by a scanning EUV mask, and
wherein each photosensitive element is electrically coupled to an adjacent photosensitive element such that accumulated electrical charge in each photosensitive element is switchably transferable to the adjacent photosensitive element in synchronicity with the scanning EUV mask; and
an analog-to-digital converter (ADC) coupled to one of the photosensitive elements disposed at an edge of the one-dimensional array.

13. The EUV mask inspection system of claim 12, wherein the plurality of photosensitive elements are illuminated from one of a backside of the substrate and a frontside of the substrate.

14. The EUV mask inspection system of claim 12, further including:
an actuator coupled to at least one of the EUV mask and the plurality of photosensitive elements.

15. An extreme ultra-violet (EUV) mask inspection method, comprising:
projecting a beam of EUV radiation onto a scanning EUV mask resulting in a patterned beam of EUV radiation;
projecting the patterned beam of radiation onto a EUV detector array, the EUV detector array comprising:
a plurality of photosensitive elements arranged in a one-dimensional array having a longitudinal axis, and formed on a substrate,
wherein each photosensitive element generates an electrical charge in response to illumination by the patterned beam of EUV radiation, and
wherein each photosensitive element is electrically coupled to an adjacent photosensitive element such that accumulated electrical charge in each photosensitive element is switchably transferable to the adjacent photosensitive element in synchronicity with the scanning EUV mask; and
an analog-to-digital converter (ADC) coupled to one of the photosensitive elements disposed at an edge of the one-dimensional array; and
outputting an output signal from the ADC.

16. The method of claim 15, wherein the plurality of photosensitive elements are illuminated from one of a backside of the substrate and a frontside of the substrate.

17. The method of claim 15, wherein an actuator coupled to at least one of the scanning EUV mask and the plurality of photosensitive elements provides relative motion between the scanning EUV mask and the EUV detector array.

18. The method of claim 15, further comprising:
comparing the output signal with a reference output signal stored in memory, wherein the reference output signal is associated with a reference mask feature and the output signal is associated with a mask feature of the scanning EUV mask that is nominally identical to the reference mask feature; and
determining a defect or irregularity of the scanning EUV mask based on the comparing.

19. The method of claim 15, further comprising:
comparing the output signal with a simulated signal stored in a database; and
determining a defect or irregularity of the scanning EUV mask based on the comparing.

20. The method of claim 15, further comprising:
comparing the output signal with a reference output signal, wherein the reference output signal is associated with a reference mask feature having a first coordinate position on the scanning EUV mask and the output signal is associated with a mask feature that is nominally identical to the reference mask feature and having a second coordinate position on the scanning EUV mask; and
determining a defect or irregularity of the scanning EUV mask based on the comparing.
